(19) United States
(12) Patent Application Publication
(10) Pub. No.: US 2022/0126450 A1
(43) Pub. Date: Apr. 28, 2022

(54) CONTROL SYSTEM AND METHOD FOR A SAFETY STATE OF A ROBOT

(71) Applicant: TECHMAN ROBOT INC., Taoyuan City (TW)

(72) Inventor: Ting-Ya Hsiao, Taoyuan City (TW)

(73) Assignee: TECHMAN ROBOT INC., Taoyuan City (TW)

(21) Appl. No.: 17/385,869

(22) Filed: Jul. 26, 2021

(30) Foreign Application Priority Data
Oct. 27, 2020 (TW) 109137548

(51) Int. Cl. B25J 9/16; B25J 13/08

(52) U.S. Cl. CPC B25J 9/1676; G05B 2219/50391; G05B 2219/40317; B25J 13/08

(57) ABSTRACT

A control system and method for a safety state of a robot. After a followed device is selected by the selection device, a safety state of a controlled device is set to follow the followed device. When a sensing device detects an object leaving a working environment, the controlled device is controlled according to the state of the followed device. The controlled device is controlled to follow the followed device to leave the safety state to improve the safety of the robot.

### BACKGROUND OF THE INVENTION

### 1. Field of the Invention

The present invention is related to a robot, and more particularly to a control system and method related to a follow selection mechanism of a robot safety state.

### 2. Description of the Prior Art

With the vigorous development of robot technology, factories use robots to assist operators in rapid processing, assembly and manufacturing operations and improve factory production efficiency, but high-speed robots seriously affect the safety of operators, so the safety control of robot working environment constitutes the main issue of maintaining the safety of robot operations.

Many factories choose robots to replace part of manpower. Therefore, in the system integration environment of the factory, for example, a robot is installed on a track, and the movement of the track is used to drive the robot to move in the working environment. A sensing device is also provided to monitor workers and other foreign objects entering and leaving the working environment of the robot. The robot, track and sensing device are integrated and controlled by a controller to maintain the safety of the robot. Once the sensing device detects a foreign object entering the robot's working environment during the robot operation, the sensing device is triggered, and the sensing device will notify the controller to take the robot and the track to a safety state such as stopping or slowing down. When the sensing device detects that the foreign object has left the working environment of the robot, the controller is notified to control the robot and the track leaving the safety state, and return to the original working state, thereby ensuring the safety of personnel and robot.

However, integrated devices usually include lower-level and higher-level controlled devices. Lower-level controlled devices such as tracks are directly controlled by the controller, and higher-level controlled devices, such as robots, have a variety of job settings, for the sake of safety, usually set that after the higher-level controlled devices are stopped, the personnel must confirm the safety before restarting. Therefore, when a foreign object has completely passed through or has entered an area that cannot be sensed by the sensing device, although the stopped robot has yet to be confirmed to restart, the controller controls the track to automatically leave the safety state and start to move, driving the robot to move, which can cause collision damage to the robot, posing a risk of safety in use. In addition, if all controlled devices are started or stopped according to the detection of the sensing device, and settings cannot be adjusted according to the characteristics of the integrated system, integration flexibility is also lost. In view of the above problems, there are still problems to be solved in controlling the safety of the robot.

### SUMMARY OF THE INVENTION

An object of the present invention is to provide a system and method for controlling the safety state of a robot, by using a selection device to select to follow a sensing device or a controlled device, the safety state of other controlled devices is set to follow the followed device to improve the flexibility and safety of robot integration.

In order to achieve the purpose of the foregoing invention, the robot safety control system of the present invention is equipped with a sensing device to detect an object entering and leaving the working environment, and generate a sensing signal accordingly. In the working environment, a safety state of a plurality of controlled devices is selected by a selection device to follow a controlled device or the sensing device. The controller connects the sensing device, a plurality of controlled devices and the selection device. The controller has a first output state and a second output state. The first output state controls the plurality of controlled devices to enter the safety state. The second output state controls the plurality of controlled devices to exit the safety state. When the selection device selects to follow the sensing device, the controller receives the entry or exit sensing signal of the sensing device and sends the first output state or the second output state to the plurality of controlled devices to enter or exit the safety state. When the selection device chooses to follow a controlled device, and the controller receives the entry sensing signal of the sensing device, the controller sends the first output state to the plurality of controlled devices to enter the safety state. When the controller receives the exit sensing signal of the sensing device, the controller sends the second output state to the followed controlled device, and then controls the safety state of other controlled devices according to the safety state of the followed controlled device.

The method for controlling the safety state of a robot of the present invention comprises first choosing to follow a sensing device or a controlled device, and using the sensing device to sense an object in and out of the working environment. When detecting a sensing signal for entering the working environment, generate a first output state to controlled devices to enter the controlled devices into a safety state. When detecting a sensing signal for leaving the working environment, and the sensing device is being followed, generate a second output state to follow the sensing signal of the sensing device, and send the second output state to the controlled devices according to the sensing signal to exit the safety state and perform normal operations. When detecting a sensing signal for leaving the working environment, and a controlled device is being followed, generate a second output state to follow the safety state of the controlled device, and send the second output state to the controlled device. When the controlled device exits the safety state, the second output state is sent to other controlled devices to exit the safety state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a control system for a robot safety state of the present invention.

FIG. 2 is a block diagram of the control system for the robot safety state of the present invention.

FIG. 3 is a block diagram of a control system for a robot safety state according to another embodiment of the present invention.

FIG. 4 is a flow chart of a method for controlling the robot safety state of the present invention.

### DETAILED DESCRIPTION

In order to achieve the above-mentioned purpose, the technical means and their effects of the present invention are described below with examples and drawings.

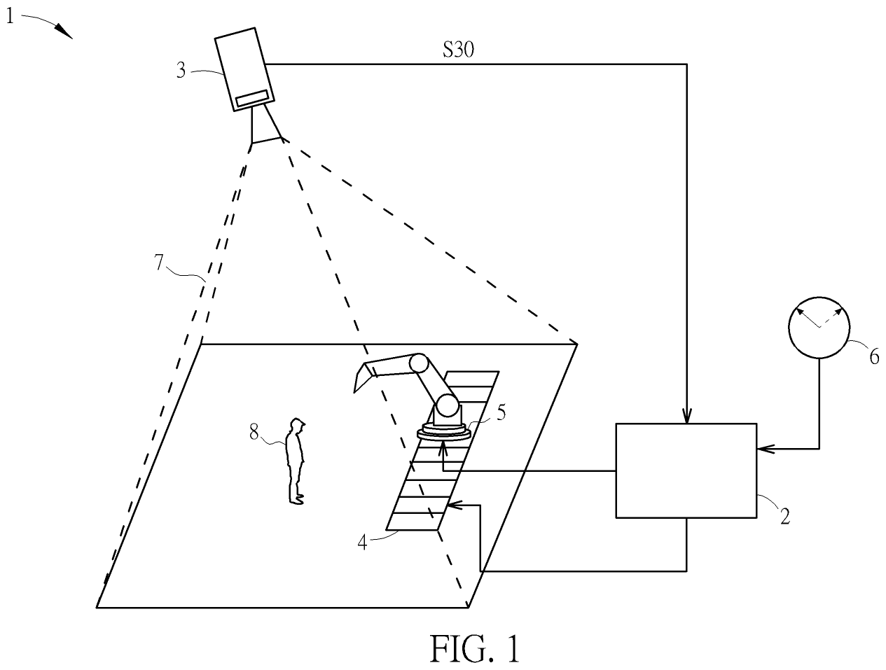

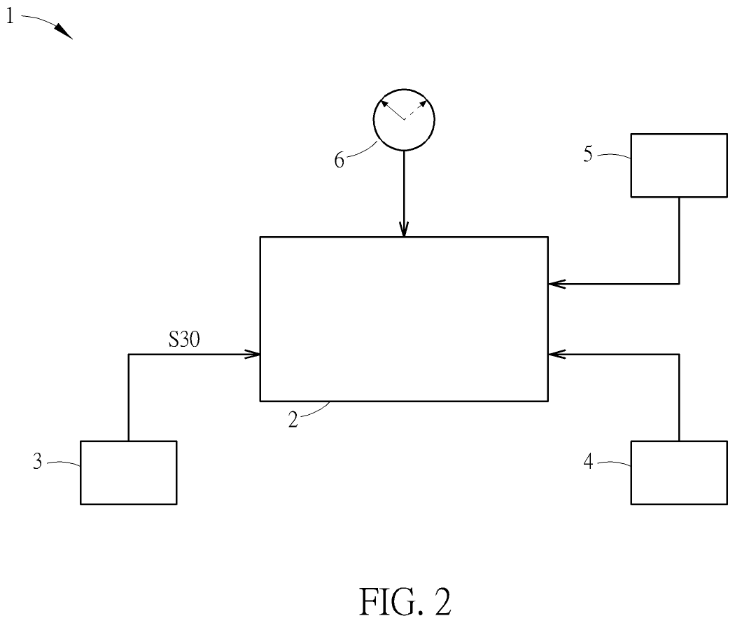

Please refer to FIGS. 1 and 2 at the same time. FIG. 1 is a schematic diagram of a control system of a robot safety state of the present invention. FIG. 2 is a block diagram of the control system for the robot safety state of the present invention. In FIG. 1, the control system 1 of the present invention is provided in a working environment 7 with a first controlled device 4 and a second controlled device 5. The working environment 7 uses a sensing device 3 to detect in and out of an object 8 (such as a foreign object). The controller 2 is connected to a sensing device 3, the first controlled device 4, the second controlled device 5, and a selection device 6. The selection device 6 can select a safety state to follow one of the controlled devices 4, 5 or the sensing device 3 via the controller 2. The sensing device 3 can be a visual sensor, but the type of the sensing device 3 can be changed according to requirements. The first controlled device 4 of the present invention can be a simple low-level device, which is directly controlled by the controller 2, such as a track. The second controlled device 5 can be a complex high-level device with its own operating settings, such as a robot, a robotic arm, or a device containing a robot or a robotic arm integrated with a track-motion operation. However the first controlled device 4 and the second controlled device 5 can both be simple low-level devices or complex high-level devices, such as two integrated robotic arms working together. The present invention includes but is not limited to the examples in this embodiment.

In FIG. 2, the control system 1 of the present invention is connected to the sensing device 3, the first controlled device 4, the second controlled device 5, and the selection device 6 by the controller 2. The controller 2 can output a first output state and a second output state. For example, the first output state and the second output state are distinguished by the high level and the low level of the signal. The first output state can control the first controlled device 4 or the second controlled device 5 to enter the safety state. The second output state can control the first controlled device 4 or the second controlled device 5 to exit the safety state. The safety state can be designed with more different states, such as deceleration, stop and pause, etc. The present invention includes and is not limited to the foregoing examples.

The selection device 6 of the control system 1 of the present invention uses a switch to select the controller 2 to output a safety state to follow a controlled device or the sensing device 3. When the selection device 6 selects to follow the sensing device 3, the controller 2 sends the first output state or the second output state to the first controlled device 4 and the second controlled device 5 according to the sensing signal S30 of the sensing device 3 to enter or exit the safety state. When the selection device 6 chooses to follow the second controlled device 5, the controller 2 sends the first output state to the first controlled device 4 and the second controlled device 5 according to the sensing signal S30 of the sensing device 3 to enter the safety state, and sends the second output state to the first controlled device 4 and the second controlled device 5 to exit the safety state according to the safety state of the second controlled device 5. In addition, although the selection device 6 in this embodiment is a switch, and the selection device 6 can be set outside the controller 2, that is, the controller 2 is externally connected to the selection device 6, the selection device 6 can be set inside the controller 2, can be a physical switch set on the first controlled device 4 or the second controlled device 5, or can be externally connected to the first controlled device 4 or the second controlled device 5 to achieve the objective of the present invention.

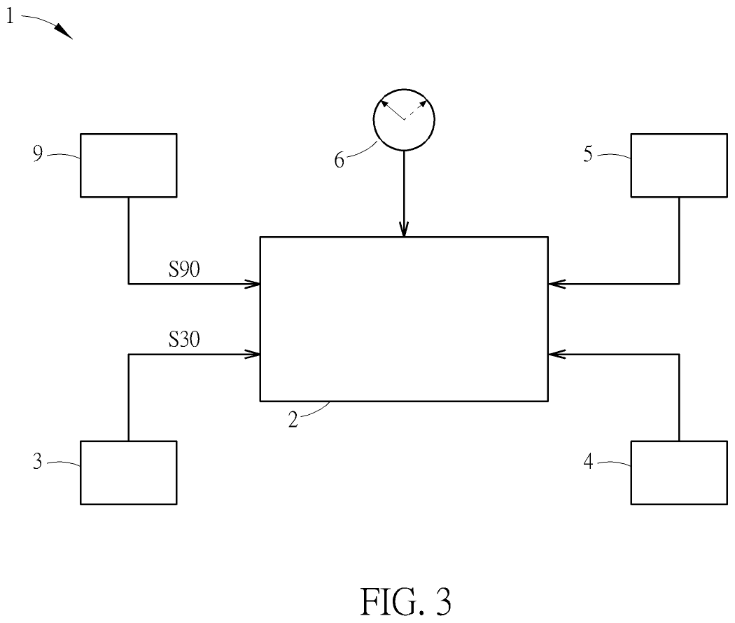

As shown in FIG. 3, it is a block diagram of a robot safety control system according to another embodiment of the present invention. The high-level second controlled device 5 of the control system 1 of the present invention, in order to maintain the flexibility to change the safety state, uses a reset device 9 externally connected to the controller 2. The reset device 9 generates a reset signal S90 to the controller 2. The controller 2 transmits the reset signal S90 to the second controlled device 5, so that the second controlled device 5 can be reset from the safety state to exit the safety state. The reset device 9 can be set to automatic reset or manual reset. When it is set to automatic reset, the controller 2 controls the second controlled device 5 to reset after the second controlled device 5 stops. When the reset device 9 is set to the manual reset, the reset of the second controlled device 5 is controlled by the user after the second controlled device 5 stops. In addition, the embodiment is not limited to changing the safety states of both of the first controlled device 4 and the second controlled device 5 at the same time. Their safety states can be changed one after another, and the change time difference of the safety states can be set by oneself. Moreover, the reset device 9 can also be arranged in the controller 2 or other places for user's convenience. The reset device 9 can be a button switch or a control icon on the human-machine interface.

When the control system for the safety state of the robot of the present invention is operating, the selection device 6 is first used to select the object to follow. When the selection device 6 selects to follow the sensing device 3, the controller 2 sets the first output state and the second output state to follow the sensing signal S30 of the sensing device 3 according to the selection signal of the selection device 6. Therefore, when the sensing device 3 senses that the object 8 enters or exits the working environment 7, the sensing signal S30 changes accordingly. When the sensing device 3 senses that the object 8 enters the working environment 7, the controller 2 sends the first output state to the first controlled device 4 and the second controlled device 5, and turns the first controlled device 4 and the second controlled device 5 to the safety state according to the sensing signal S30. When the sensing device 3 senses that the object 8 leaves the working environment 7, the controller 2 sends a second output state to the first controlled device 4 and the second controlled device 5 to exit the safety state of the first controlled device 4 and the second controlled device 5 according to the sensing signal S30. And the first controlled device 4 and the second controlled device 5 return to the normal operations.

But when the selection device 6 selects to follow the second controlled device 5, the controller 2 sets the first output state to follow the sensing device 3 and the second output state to follow the second controlled device 5 according to the selection signal of the selection device 6. Therefore, when the sensing device 3 senses that the object 8 enters the working environment 7, the controller 2 sends the first output state to the first controlled device 4 and the second controlled device 5 according to the sensing signal S30 to take the first controlled device 4 and the second controlled device 5 to the safety state. When the sensing device 3 senses that the object 8 leaves the working environment 7, the controller 2 only sends the second output state to the second controlled device 5. If the second controlled device 5 has left the safety state due to automatic reset, then the controller 2 sends the second output state to the first controlled device 4, and exits the safety state of the first controlled device 4 so that the first controlled device 4 can perform normal operations. If after receiving the second output state, the second controlled device 5 still stays in the safety state due to manual reset, then the controller 2 does not send the second output state to the first controlled device 4, so that the first controlled device 4 can also stay in the safety state. The controller 2 would then send the second output state to the first controlled device 4 when the second controlled device 5 changes to leave the safety state due to manual reset, so that the first controlled device 4 can exit the safety state and perform normal operations.

In addition, the reset device 9, the selection device 6, the sensing device 3, the first controlled device 4, and the second controlled device 5 are mere examples for illustration. The present invention includes but is not limited to this embodiment. The quantity can be reduced or increased according to requirement. Alternatively, the first controlled device 4 and the second controlled device 5 may be controlled by different controllers, and the following state may be set between the two controllers, which all belong to the scope of the present invention.

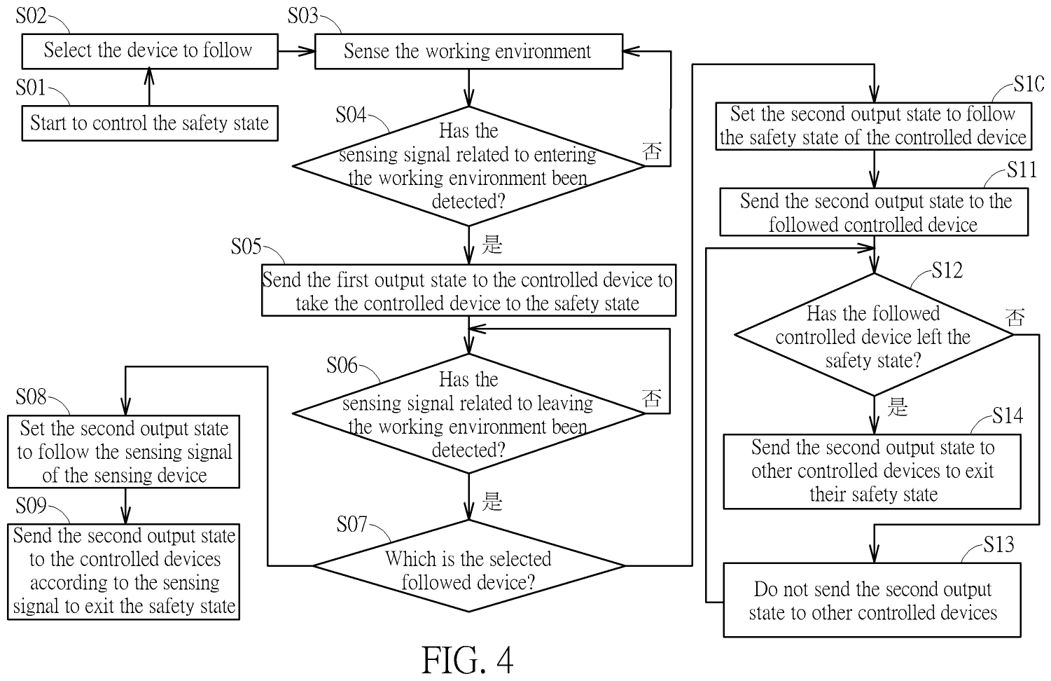

Please refer to FIG. 4, which is a flowchart of a method for controlling the safety state of the robot of the present invention. The steps of the method for controlling the safety state of the robot of the present invention are described as follows: Step S01, start to control the safety state; Step S02, select the device to follow; Step S03, the sensing device senses the entry and exit of an object (such as personnel or other equipment) to the working environment; step S04, check whether the sensing signal S30 related to entering the working environment is generated? If the sensing signal S30 related to entering the working environment is not generated, go back to step S03 to continue sensing the sensing signal S30, if the sensing signal S30 related to entering the working environment is generated, go to step S05, send the first output state to the controlled device to take the controlled device to the safety state; then go to step S06, check whether the sensing signal S30 related to leaving the working environment is generated? If no sensing signal S30 related to leaving the working environment is generated, then continue to sense the sensing signal S30, if the sensing signal S30 related to leaving the working environment is generated, go to step S07, check if the followed device is the sensing device or a controlled device? If the followed device is the sensing device, go to step S08 to set the second output state to follow the sensing signal S30 of the sensing device, and then go to step S09 to send the second output state to the controlled devices according to the sensing signal S30 to exit the safety state and perform normal operations.

In step S07, if the followed device is a controlled device, go to step S10 to set the second output state to follow the safety state of the controlled device, and then to step S11 to send the second output state to the followed controlled device. In step S12, check if the followed controlled device has left the safety state? If the followed controlled device has not left the safety state, go to step S13, do not send the second output state to other controlled devices to maintain their safety state, and return to step S12 to continue to check the safety state of the followed controlled device. If the followed controlled device has left the safety state, go to step S14 to send the second output state to other controlled devices to exit their safety state.

In summary, the system and method for controlling the safety state of the robot of the present invention can use the selection device to select to follow the sensing device or a controlled device, and set the safety state of other controlled devices to follow the followed device. When the sensing device detects an object leaves the working environment, the controlled devices are controlled to exit the safety state according to the state of the followed device to enter the normal operation, so as to achieve the safety of the robot integration in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control system for safety of a robot, comprising:
a sensing device configured to detect an object in and out of a working environment for generating a sensing signal;
a plurality of controlled devices disposed in the working environment;
a selection device configured to select the sensing device or one of the controlled devices to follow a safety state; and
a controller connected to the sensing device, the plurality of controlled devices and the selection device, the controller having a first output state controlling the plurality of controlled devices to enter the safety state, and a second output state controlling the plurality of controlled devices to exit the safety state;
wherein the selection device selects the safety state to follow the sensing device or one of the controlled devices, when the sensing device is selected, the controller receives an entry sensing signal or an exit sensing signal of the sensing device, and sends the first output state or the second output state to the controlled devices for the controlled devices to enter or exit the safety state; when a controlled device is selected, the controller receives the entry sensing signal of the sensing device, and sends the first output state to the controlled devices to enter the safety state, and when the controller receives the exit sensing signal of the sensing device, the controller sends the second output state to the controlled device, and controls the safety state of remaining controlled devices according to the safety state of the control device.

2. The control system of claim 1 wherein the controller sends the second output state to the remaining controlled devices to exit the safety state after the controlled device exits the safety state; and the controller does not send the second output state to the remaining controlled devices if the controlled device is in the safety state.

3. The control system of claim 1 wherein the safety state is controlling the controlled device to decelerate, stop or halt.

4. The control system of claim 1 wherein the first output state has a high voltage level, and the second output state has a low voltage level.

5. The control system of claim 1 wherein the controlled device is a low-level controlled device directly controlled by the controller, or a high-level controlled device with a variety of settings.

6. The control system of claim 5 wherein the low-level controlled device is a track, and the high-level controlled device is a robot.

7. The control system of claim 1 wherein the selection device is a switch externally connected to the controller, set inside the controller, a physical switch set on one of the controlled devices, or externally connected to the controlled devices.

8. The control system of claim 1 wherein the controller is connected to a reset device, the reset device generates a reset signal to the controller and controls the controlled devices to reset so as to exit the safety state.

9. The control system of claim 8 wherein when the reset device is in an automatic reset mode, the controller automatically resets the controlled devices after the controlled devices stop; and when the reset device is in a manual reset mode, the controlled devices are reset by a user after the controlled devices stop.

10. The control system of claim 8 wherein the reset device is a button switch, or a control icon on a human-machine interface.

11. A control method of a robot safety state comprising:
selecting to follow a sensing device or a controlled device;
using the sensing device to sense an object in and out of a working environment;
when receiving a sensing signal related to an entry of the object to the working environment, sending a first output state to the controlled device to take the controlled device to a safety state;
when receiving a sensing signal related to an exit of the object from the working environment, and the controlled device is being followed, setting a second output state to follow the safety state of the controlled device;
sending the second output state to the controlled device; and
when the controlled device leaves the safety state, sending the second output state to remaining controlled devices for the remaining controlled devices to leave the safety state.

12. The control method of claim 11 wherein when the sensing signal related to the entry of the object to the working environment has not been detected, continuing to detect the sensing signal related to the entry of the object to the working environment.

13. The control method of claim 11 wherein when the sensing signal related to the exit of the object from the working environment has not been detected, continuing to detect the sensing signal related to the exit of the object from the working environment.

14. The control method of claim 11 wherein when the controlled device leaving the safety state has not been detected, the second output state is not sent to the remaining controlled devices, the remaining controlled devices remain in the safety state, and the controlled device leaving the safety state continues to be checked.

15. The control method of claim 11 wherein when the sensing device is being followed, set the second output state to follow the sensing signal of the sensing device, and send the second output state to the controlled device according to the sensing signal to take the controlled device out of the safety state to perform normal operations.
